(19) United States
(12) Patent Application Publication
(10) Pub. No.: US 2019/0309545 A1
(43) Pub. Date: Oct. 10, 2019

(54) LOCKING MECHANISM FOR A STORAGE COMPARTMENT WITH A LID AND A STORAGE COMPARTMENT WITH SUCH A LOCKING MECHANISM

(71) Applicant: Faurecia Innenraum Systeme GmbH, Hagenbach (DE)

(72) Inventor: Jürgen Ries, Essingen (DE)

(21) Appl. No.: 16/379,618

(22) Filed: Apr. 9, 2019

(30) Foreign Application Priority Data
Apr. 10, 2018 (DE) 10 2018 205 382.0

(51) Int. Cl. E05B 77/06; E05B 83/30

(52) U.S. Cl. CPC E05B 77/06; E05B 83/30

(57) ABSTRACT

The disclosure relates to a locking mechanism for a storage compartment with a lid, such as for a storage compartment with a lid for a vehicle interior. The disclosure further relates to a storage compartment with a lid comprising such a locking mechanism. The locking mechanism comprises a first stop, a locking element and a collision element. The locking element has a hook, wherein the hook for locking the locking mechanism is pivotable from a first position into a second position and vice versa. In the second position, the hook engages at least in part behind the first stop. In the event of an accident the locking element can be plastically deformed so that an opening of the storage compartment is prevented.

### CROSS-REFERENCE TO RELATED APPLICATION

This application claims priority to German Application No. 10 2018 205 382.0, filed Apr. 10, 2018, which is herein incorporated by reference in its entirety.

### TECHNICAL FIELD

The disclosure relates to a locking mechanism for a storage compartment with a lid, such as for a storage compartment with a lid for a vehicle interior. The disclosure further relates to a storage compartment with a lid comprising such a locking mechanism.

### BACKGROUND

Various locking mechanisms for storage compartments with lids are known from prior art. Regarding storage compartments in vehicle interiors, it is particularly important that the storage compartment remains closed in the event of an accident. This means that the lid should not open due to sudden braking operations or impact forces acting on it in the case of an accident.

This problem is addressed, for example, in the teachings of U.S. Pat. No. 9,080,353 B2. There, a locking element is arranged in a groove in such a way that during a sudden deceleration it shifts within the groove and is thus locked in a closed position.

U.S. Pat. No. 4,552,399 describes a glove compartment for the dashboard of a motor vehicle. The glove compartment comprises a pivotable lid. A hook is pivotally mounted next to one of the arms. In order to prevent an opening of the lid during a sudden deceleration, a weight is arranged in such a way that the weight swings against the hook during a sudden deceleration and engages it with the lid.

The present disclosure therefore has the object of suggesting an alternative locking mechanism which solves the above problem. The disclosure further has the object of proposing such a storage compartment.

### SUMMARY

The locking mechanism is particularly suited for a storage compartment with a lid, such as for a storage compartment with a lid for a vehicle interior. The locking mechanism comprises a first stop, a locking element and a collision element. The locking element has a hook, wherein the hook for locking the locking mechanism is pivotable from a first position into a second position and vice versa. In the second position, the hook engages at least in part behind the first stop. In one embodiment, the hook is pivotally arranged on the lid.

The locking element may comprise a spring which exerts a force on the locking element in order to pivot the locking element from a first position into the second position or to keep the locking element in the second position. In one embodiment, in which the locking element is arranged on the lid, a spring is preferably also arranged on the lid.

The collision element is arranged in relation to the locking element such that the locking element is moved with respect to and collides with the collision element when a force exceeding a predefined value acts directly and/or indirectly on the locking element. In the process, the locking element may be moved in the direction of the collision element and/or the collision element may be moved in the direction of the locking element. For example, in a storage compartment, an elastic material may be arranged between the lid and the body. The force exceeding the specified value can compress the elastic material such that the locking element collides with the collision element.

The collision element and the locking element may be configured such that the collision element prevents the locking element from unlocking by way of the force exceeding the predefined value, or such that the impact of the collision element on the locking element during the collision prevents an unlocking of the locking mechanism after the collision.

The collision element and the locking element may be configured such that during a collision with the collision element, the locking element is shifted and/or plastically deformed such that the locking element engages positively and/or frictionally with the first stop.

A storage compartment comprising the described locking mechanism is therefore typically closed and locked when the hook is in the second position and open when the hook is in the first position. Typically, only the locking element is pivotable. However, it is also possible for only the hook of the locking element to be configured to be pivotable. In order to unlock the locking mechanism, the hook is pivoted into the first position so that the hook no longer engages behind the first stop. The hook may, for example, be configured to be L-shaped. The hook may however also be configured to be arched and/or U-shaped and may for example lie against only one curved contact surface or also against three or more contact surfaces on the first stop or protrude into an indentation in the stop. An unlocking may be achieved by a user for example by operating a release button or release lever.

A force acting indirectly and/or directly on the locking element may for example occur in the event of an accident. The force may then act directly on the locking element due to a mass, for example an airbag or a vehicle occupant, acting on the release button or the release lever. The force may also act indirectly on the locking element by a mass acting on the lid of the storage compartment or on another element of the storage compartment and this in turn colliding with the locking element. For instance, in the event of an accident a sudden deceleration may cause the head of a passenger to collide with a lid of a storage compartment comprising the locking mechanism, for example a glove compartment. The materials and the shaping of the locking element and the collision element are typically selected such that the locking element is only moved against the collision element when the force exceeds a predefined value. The purpose of this is to prevent the locking element from colliding with the collision element as a result of weaker forces, which may for example occur when a passenger bumps the storage compartment during normal use, or which correspond to a force for normal unlocking and opening of a storage compartment, and also to prevent irreversible unlocking caused by a deformation of the locking element. The predefined value may for example be 15 N, preferably at least 30 N, particularly preferably at least 50 N.

It may additionally be provided that the locking element is moved into a self-retaining, particularly a latched position on a second or a third stop due to a plastic or elastic deformation or a displacement of the locking element resulting from the collision with the collision element.

During the collision with the collision element, the locking element makes a larger movement than during a normal locking or unlocking operation. During the collision, the collision element may displace or plastically deform the locking element to a degree that it engages the second or third stop and is latched or locked there. This allows the locking element to be permanently locked such that no unlocking can take place and either the locking of the locking element with the second or third stop takes the place of the locking with the first stop, or the locking with the second or third stop complements the locking with the first stop.

The locking element may have an additional hook or another element with an indentation or a latching element or a stop for locking with the second or third stop.

The materials and the shaping of the locking element and the collision element may be selected such that under the influence of a force exceeding the predefined value during a collision of the locking element with the collision element, the locking element in particular is plastically deformed. It may however also be provided that the collision element is also at least partially deformed. It may further be provided that the first stop is deformed instead of or in addition to the collision element. The locking element is preferably made of a first plastic or comprises a first plastic. The collision element is preferably made of a second plastic or comprises a second plastic. The locking element, in particular the hook, may for example be made of POM or PC/ABS or comprise POM or PC/ABS. The collision element and the box of the storage compartment may for example be made of ABS/PC or comprise ABS/PC or ABS. It may also be provided that the hook and the collision element be made of the same plastic. The collision element may be configured to be more rigid and/or harder than the locking element.

The collision element may have a collision surface along which the locking element may slide during the deformation, such that the deformation of the locking element can be directed/defined by the collision element. In addition to being deformed due to or during a collision, the locking element may therefore also be shifted.

The locking element can, due to a collision with the collision element, be deformed at least sectionally such that the locking element positively and/or frictionally engages the stop. Alternatively or additionally, the stop may be deformed and positively and/or frictionally engage the locking element.

During a collision, the kinetic energy of the locking element may be converted into thermal energy by a friction between the locking element and the collision element. The heat may cause at least a partial melting of a surface of the collision element and/or the locking element such that during a collision, an adhesive bonding may also take place at least sectionally between the collision element and the locking element. It may be provided that the liquid limit of the locking element material is lower than the liquid limit of the collision element material. The liquid limit is the temperature at which the respective material begins to flow or to start becoming liquid. An advantage of such a connection of the locking element and the stop or of the locking element and the collision element may be that this achieves a secure fixation of the lid and the storage compartment remains closed after an accident.

The locking mechanism may further comprise a second stop. After a collision with the collision element, the locking element may be plastically deformed as explained above. The preferably plastically deformed locking element may be positively and/or frictionally engaged with the second stop after colliding with the collision element. The second stop may for example be arranged on a lid. The second stop preferably additionally secures the locking element in the position in which the plastically deformed locking element is connected to the first stop. A plastically deformed region of the locking element may be positively and/or frictionally engaged with the second stop, however a non-deformed region of the locking element may additionally or alternatively be accordingly connected to the second stop.

The locking mechanism may comprise a lock aperture. The locking element may be configured such during normal use of the locking mechanism, that is to say during normal opening and closing of the storage compartment lid, the hook already protrudes through the lock aperture. The region of the locking element that may protrude through the lock aperture when the hook is pivoted from the first position into the second position and vice versa may have a cross-section that is smaller than the diameter or a length and/or width of the lock aperture such that the locking element typically does not come into contact with an edge bounding the lock aperture during an opening or closing of the storage compartment. The locking element may however also be configured such that, when the hook pivots from the first position into the second position, the hook does not protrude into the lock aperture. A lock aperture may thus be arranged below the hook that is in the second position and may only be moved into the lock aperture by a force exceeding the predefined value.

The locking element may further have a first section which in a cross-section has a lateral extension that substantially corresponds to a width or length or to a diameter of the lock aperture. The collision element and the lock aperture may be configured such that upon a collision of the locking element with the collision element, the first section of the locking element at least partially plunges into the lock aperture and frictionally engages the lock aperture. Here, plunging may mean that the locking element plunges further into the lock aperture; this applies, in particular, when the locking element has a section which, when the hook pivots from the first into the second position and vice versa, at least partially protrudes through the lock aperture. Plunging may also mean that a section of the locking element requires a force exceeding the predefined value in order to plunge into the lock aperture. The plunging of the first section into the lock aperture allows for an additional securing of the plastically deformed locking element in a position in which the storage compartment is closed. To this end, the lock aperture may be arranged on a lid or on the box of the storage compartment. When the locking element and the lock aperture are both part of the lid or when the locking element and the lock aperture are both part of the box of the storage compartment, the frictional engagement of the lock aperture with the plastically deformed locking element may secure the plastically deformed locking element in a collision position, that is to say the position of the plastically deformed locking element after the collision with the collision element. When the locking element and the lock aperture are on different components, for example when the locking element is part of the lid and the lock aperture is part of the storage compartment box, the frictional engagement of the lock aperture with the plastically deformed locking element may allow for an additional connection between the lid and the storage compartment interior such that in addition to the connection between the locking element and the first stop, a second connection may exist between the storage compartment interior and the lid. The first stop may be arranged on the lock aperture, for example forming an edge of the lock aperture.

The locking element may have a second hook. The locking mechanism may have a third stop. The collision element and the lock aperture may be configured such that upon a collision of the locking element with the collision element, the second hook engages behind the third stop at least in part.

The disclosure further relates to a storage compartment comprising a box with an engagement aperture, a pivotable lid to close the engagement aperture and the locking mechanism described above. The box comprises a box interior into which a user can reach via the engagement aperture. The user may thus store things in the box and take them out. The engagement aperture can be closed using the lid such that the box interior is closed.

The locking element described above can be pivotally connected to the lid and the collision element can be rigidly connected to the box or form a part of the box. It is understood that the locking element described above may alternatively be pivotally connected to the box and the collision element may be rigidly connected with the lid or form a part of the lid.

The first stop may be rigidly connected to the box or be configured to be integral with the box. The second stop may be rigidly connected with the lid or be configured to be integral with the lid. The third stop may be rigidly connected to the box or be configured to be integral with the box.

The storage compartment may be arranged in a vehicle interior, may for example form a glove compartment or be recessed in the center console.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

Exemplary embodiments are described in conjunction with the following figures.

The figures are as follows:

FIG. 1 is a perspective view of a storage compartment,

FIG. 2 is a cross-section of the storage compartment of FIG. 1 in perspective view,

FIG. 3 is a schematic sectional view of the storage compartment of the preceding figures, wherein the storage compartment is shown in an at least partially opened state,

FIG. 4 is a schematic sectional view of the storage compartment of the preceding figures, wherein the storage compartment is shown in an excessively pressed closed position,

FIG. 5 is a schematic sectional view of the storage compartment of the preceding figures, wherein the storage compartment is shown in a closed position,

FIG. 6 is a schematic sectional view of the storage compartment of the preceding figures, wherein the storage compartment is shown in a locked crash position,

FIGS. 7A and 7B are two schematic sectional views of the storage compartment of the preceding figures in two different positions, wherein the storage compartment comprises a second stop,

FIG. 8 is a schematic view of a locking element comprising a first and a second hook; and

FIGS. 9A-9C are schematic representations of a locking element and a lock aperture.

### DETAILED DESCRIPTION

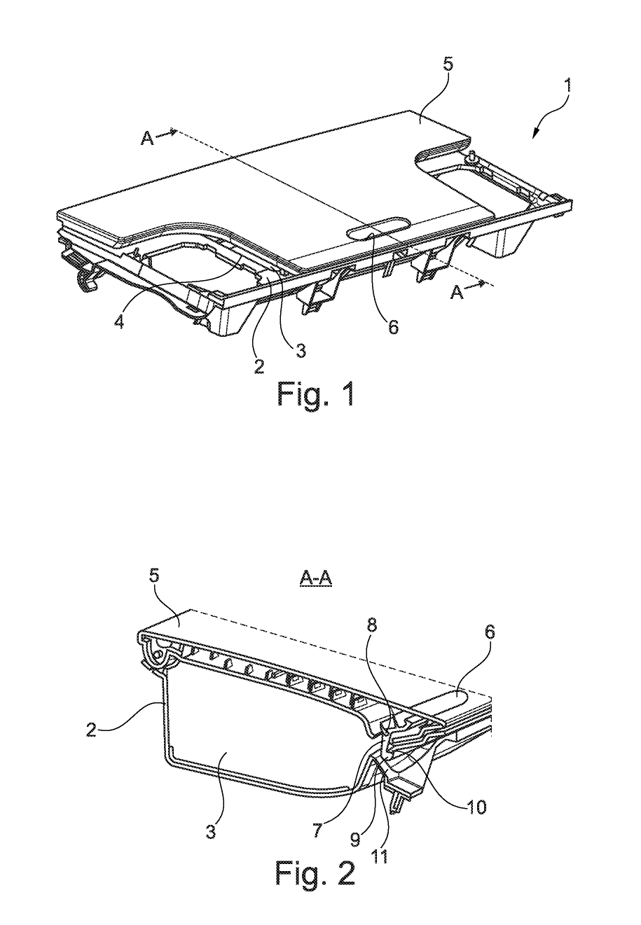

In FIG. 1, a storage compartment 1 is shown in a perspective view. The storage compartment comprises a box 2 with a storage compartment interior 3 and an engagement aperture 4. The storage compartment further comprises a lid 5 which is pivotally connected to the box 2 and clears the engagement aperture 4 in a first position and covers the engagement aperture in a second position. The storage compartment further comprises a locking mechanism that can be unlocked by a user using a release button 6. The locking mechanism is shown in the sectional view AA of the following figures. Pressing the release button 6 allows a locking element to be pivoted around an axis 8. In FIG. 2, for example, the storage compartment is shown in a closed state with the lid locked. The locking element is arranged on the lid 5 and has a hook 9. A first stop 10, which the hook 9 engages behind in the closed and locked position, is arranged on the box 2. A first spring, which is unloaded in an open lid position and is preloaded in a closed lid position, is arranged between the lid 5 and the box 2. This first spring may for example be arranged in the hinge region of the lid.

The lid 5 is held in its closed position and the first spring is preloaded by the engaging of the hook 9 behind the first stop 10. By operating the release button, the fixing of the hook on the stop is released and the first spring may be unloaded such that the lid opens. A collision element 11 is arranged below a locking element. When, for instance during an accident, a force exceeding a predefined value acts on the lid 5, for example a force greater than 15 N or even one greater than 50 N, the lid 5 is moved towards the collision element 11 with the arranged locking element 7 and the locking element 7 is pressed against the collision element 11. The force acting on the lid allows the outside of the lid 5 to be deformed and pushed against the locking element 7. An elastic material, for example a rubber or a spring element, may be arranged between the lid and the box to define the predefined value of the force which must be exceeded in order press the locking element 7 against the collision element 11.

The collision element is configured such that when the locking element 7 collides with the collision element 11, the locking element 7 cannot pivot into the first position and the lid does not open. The collision element 11 may for example have an indentation as shown in the FIGS. 2 through 7.

The locking element 7 may be plastically deformed upon collision with the collision element 11. The plastic deformation may for example lead to the locking element 7 and the first stop 10 becoming wedged. A positive or frictional engagement is thus created between the locking element 7 and the first stop 10 such that the lid is locked in a closed position during an accident. The locking element 7 may be plastically deformed as well as shifted upon colliding with the collision element. To this end, the collision element 11 may, for example, have a beveled surface along which the locking element 7 slides during a collision.

In the following figures, recurring characteristics are marked using the same reference numerals.

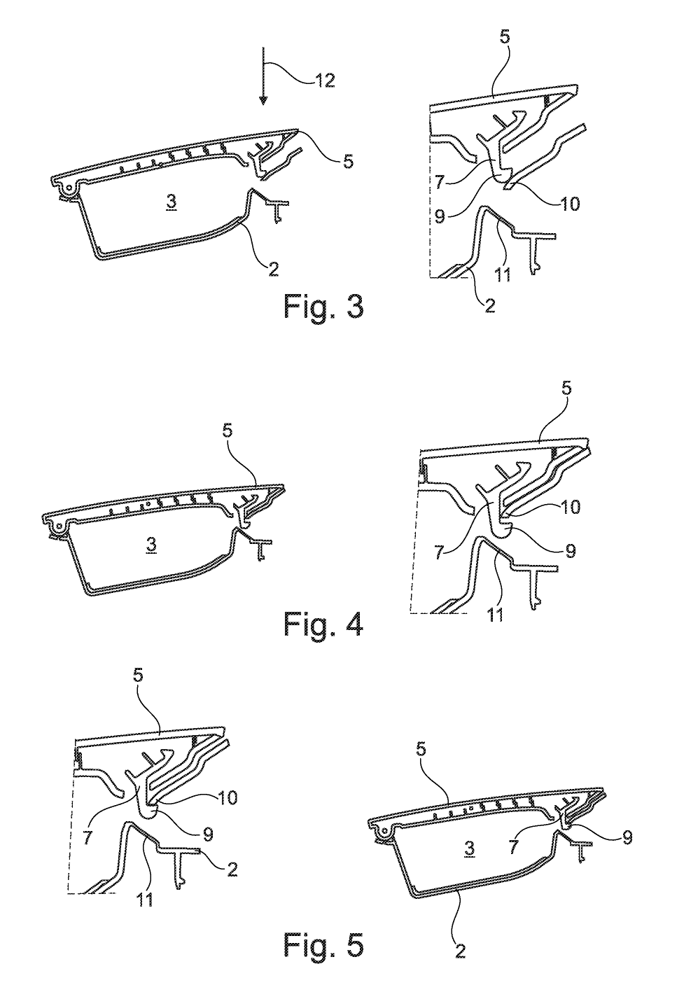

On the left-hand side of FIG. 3, a schematic sectional view of the storage compartment 1 of the previous figures is shown. On the right-hand side, a magnified view of the locking mechanism is shown. In FIG. 3 the storage compartment is shown in an at least partially open position. The storage compartment 1 may be closed by a user by exerting a force, which is smaller than the predefined value, on the lid 5 in the direction of the arrow 12. In so doing, the hook 9 slides along the first stop 10 such that the two engage. FIG. 4 shows a storage compartment in an excessively pressed closed position, with a user exerting a compressive force on the lid 5. When the user releases the lid 5, the locking element, in particular the hook, moves into its second position. The movement of the hook may be achieved by a second spring which pushes the hook in the direction of the stop. In a different embodiment, the pivotable hook is designed such that its stable position is the second position, for example under the influence of the gravitational force.

After the user releases the lid, the first spring moves the lid 5 into the reversibly locked, closed position, in which the hook 9 is engaged with the first stop 10. This position is shown in FIG. 5.

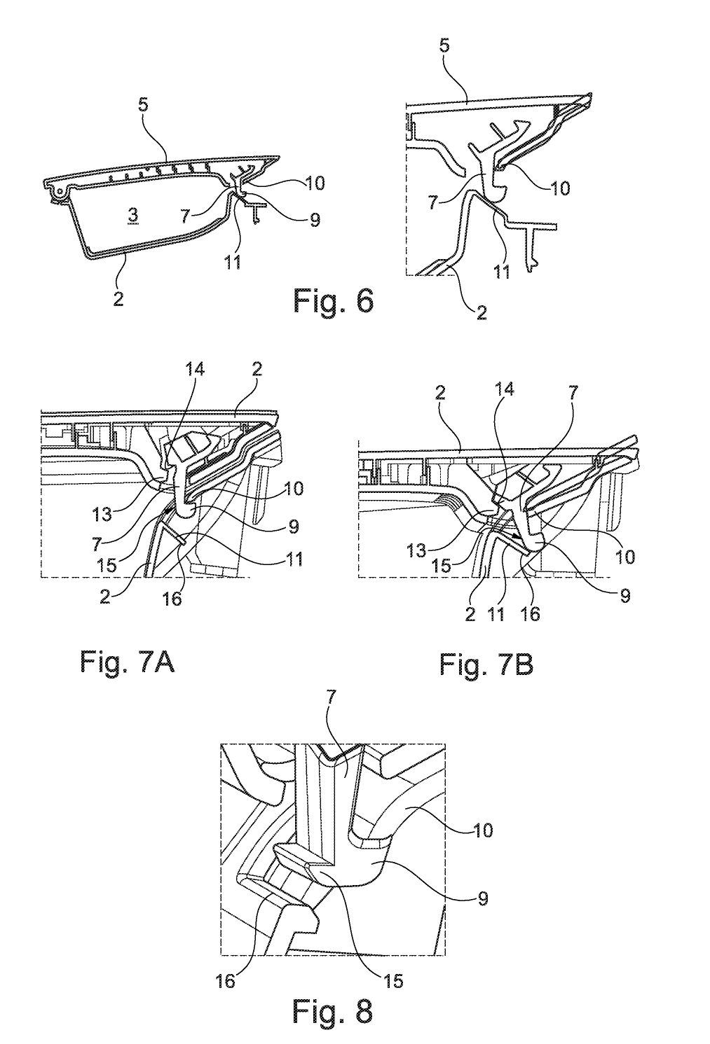

In FIG. 6 the storage compartment is shown in a crash position. The potentially plastically deformed locking element 7 engages behind the first stop 10 at least in part such that the lid 5 is positively connected to the box 2. In FIG. 7B the locking element 7 is represented at a later point in time of a deformation by a collision, in which the positive connection between the first stop 10 and the locking element 7 can be clearly seen.

The locking mechanism in FIGS. 7A and 7B is the same as the locking mechanisms of the previous figures, however it further comprises a second stop 13, the shape of which corresponds to a region 14 of the locking element 7, which region comprises a stop. In FIG. 7A the lid 2 is shown in a closed position and the hook 9 of the locking element 7 is engaged with the stop 10. The second stop 13 is arranged at a distance from the corresponding region 14 of the locking element 7. By contrast, FIG. 7B shows the plastically deformed locking element 7 after an accident, in which a force exceeding the predefined value has been exerted on the locking element 7, causing it to be plastically deformed. The locking element 7 is positively connected to the stop 10. Furthermore, the second stop 13 is engaged with the corresponding region 14 of the locking element 7 comprising the stop. The second stop 13 and the corresponding region 14 of the locking element 7 interlock according to the lock-and-key principle. The plastically deformed locking element 7 is thus secured in this position.

The second stop 13 and the stop in the region 14 of the locking element may also be replaced by an elastic latching connection.

FIG. 8 shows a schematic representation of the hook 9 of a locking element 7. The locking element 7 is essentially the same as the locking element 7 of the previous figures, however this locking element 7 comprises a second hook 15 which is located on the rear side of the hook 9 and is mirror-inverted thereto. In the event of a crash, this second hook may be engaged with a third stop. This third stop may, for example, be arranged on the collision element 11 and, by way of example, is marked with the reference numeral 16 in FIG. 7B. This allows the locking element 7 to be permanently locked to the collision element in the case of a crash.

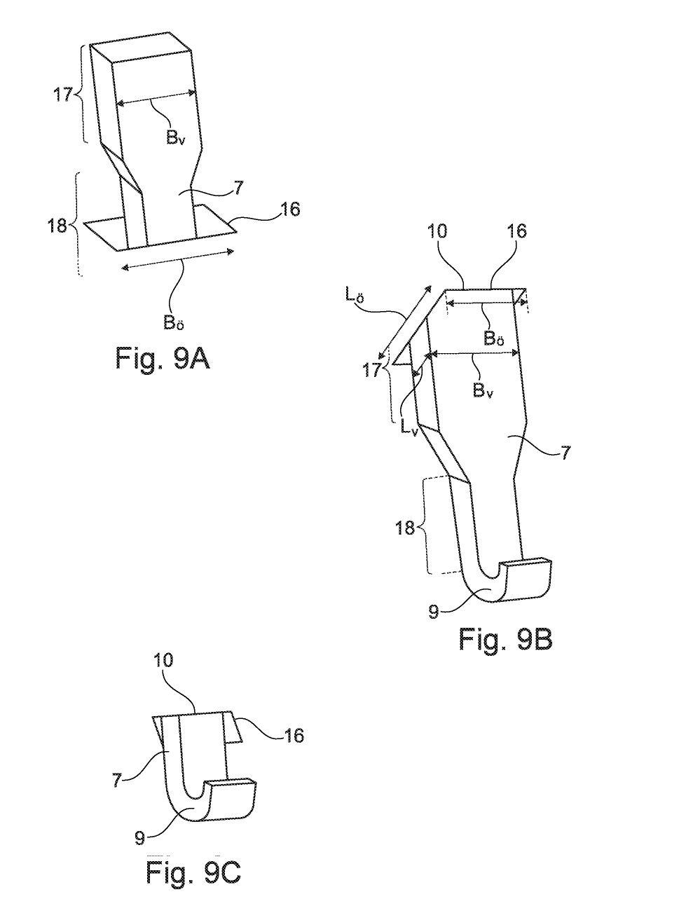

FIGS. 9A through 9C show schematic representations of a locking element 7 and a lock aperture 16 which may be part of the locking mechanisms described above. The lock aperture 16 may, for example, be part of the box 2 and is identified and marked with reference numeral 16 in FIG. 8 by way of example. The stop 10 is a boundary of the lock aperture 16. An upper section 17 of the locking element 7 substantially has the same width By as the width of the lock aperture Bö. During normal use of the storage compartment, that is to say when a force acting on the lid is smaller than a predefined value, only the lower section 18 of the locking element 7 protrudes through the lock aperture 16 (cf. FIG. 9A and FIG. 9C). When the lid is in a closed position, the hook 9 engages behind the stop 10 and secures the lid 5 in the closed position. When a force exceeding the predefined value acts on the locking element 7, the locking element 7 is pressed down through the lock aperture and the upper section 17 protrudes through the lock aperture 16. The locking element becomes wedged against the lock aperture 16 and the locking element 7 is secured in the crash position. Alternatively or additionally to the widths By and Bö being substantially equal, the lengths Lv of the locking element and the length Lo of the lock aperture may be substantially equal.

The disclosure may further relate to the following aspects, which may also be combined with the characteristics of the patent claims.

First aspect: Locking mechanism for a storage compartment (1) with a lid (5), such as for a vehicle interior, comprising

a first stop (10),

a locking element (7) with a hook (9), wherein for locking the locking mechanism the hook (9) is pivotable from a first position into a second position and vice versa and, in the second position, the hook (9) engages behind the first stop (10) at least in part,

a collision element (11) arranged at a distance from the locking element such that the locking element (7) is moved relative to and collides with the collision element (11) when a force exceeding a predefined value acts directly and/or indirectly on the locking element (7),

wherein the collision element (11) and the locking element (7) are formed in such a manner that the collision element (11) prevents an unlocking of the locking mechanism (7) initiated by the force exceeding the predefined value.

Second aspect: A locking mechanism according to aspect 1, characterized in that upon collision, the locking element (7) is plastically deformed in such a way that the locking element (7) positively and/or frictionally engages the first stop (10).

Third aspect: A locking mechanism according to aspect 1 or 2, characterized by a second stop (13) that the locking element (7) additionally engages positively and/or frictionally after a collision with the collision element (11).

Fourth aspect: A locking mechanism according to one of the preceding aspects, characterized in that the locking element (7) comprises a spring which exerts a force on the locking element (7) in order to pivot the locking element (7) into or to keep it in the second position.

Fifth aspect: A locking mechanism according to one of the preceding aspects, characterized in that the predefined value of the force is at least 15 N, preferably at least 30 N, particularly preferably at least 50 N.

Sixth aspect: A locking mechanism according to one of the preceding aspects, characterized in that a liquid limit of the locking element (7) is lower than a liquid limit of the collision element (11), wherein the locking element (7) is preferably made of a first plastic or comprises a first plastic and the collision element (11) is preferably made of a second plastic or comprises a second plastic.

Seventh aspect: A locking mechanism according to one of the preceding aspects, characterized by a lock aperture (16), wherein the locking element (7) has a first section (19) comprising, in cross-section, a lateral extension (By), which substantially corresponds to a width (Bö) of the lock aperture (16), wherein the collision element (11) and the locking element (7) are configured such that during a collision of the locking element (7) with the collision element (11), the first section (17) of the locking element (7) plunges into the lock aperture (16) at least partially and frictionally engages the lock aperture (16).

Eighth aspect: A locking mechanism according to aspect 5, characterized in that the first stop (10) is arranged on the lock aperture.

Ninth aspect: A locking mechanism according to one of the preceding aspects, characterized in that the locking element (7) comprises a second hook (15) and the collision element (11) and the locking element (7) are configured such that when the locking element (7) collides with the collision element (11) the second hook (15) engages behind a third stop (16) at least in part.

Tenth aspect: A storage compartment, comprising a box (2) with an engagement aperture, a pivotable lid (5) for closing the engagement aperture (4) and a locking mechanism according to according to one of the preceding aspects, characterized in that the locking element (7) is pivotally connected with the lid (5) and the collision element (11) is rigidly connected to the box (2) or forms a part of the box (2).

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

The following is claimed:

1. A locking mechanism for a storage compartment with a lid, for a vehicle interior, comprising:
a first stop;
a locking element with a hook, wherein for locking the locking mechanism the hook is pivotable from a first position into a second position and vice versa and, in the second position, the hook engages behind the first stop at least in part; and
a collision element arranged in relation from the locking element such that the locking element is moved relative to and collides with the collision element when a force exceeding a predefined value acts one of directly or indirectly on the locking element,
wherein the collision element and the locking element are configured such that the impact of the collision element on the locking element that occurs during the collision prevents an unlocking of the locking mechanism after the collision.

2. A locking mechanism according to claim 1, characterized in that the locking element is moved into a self-retaining, particularly a latched position on a second or a third stop due to a deformation or a displacement of the locking element resulting from the collision with the collision element.

3. A locking mechanism according to any of claims 1 and 2, characterized in that upon collision, the locking element is plastically deformed in such a way that the locking element (7) positively and/or frictionally engages the first stop.

4. A locking mechanism according to any of claims 1 and 2, characterized by a second stop that the locking element additionally engages positively and/or frictionally after a collision with the collision element.

5. A locking mechanism according to any of claims 1 and 2, characterized in that the locking element comprises a spring which exerts a force on the locking element in order to pivot the locking element into or to keep it in the second position.

6. A locking mechanism according to any of claims 1 and 2, characterized in that the predefined value of the force is at least 15 N, preferably at least 30 N, particularly preferably at least 50 N.

7. A locking mechanism according to any of claims 1 and 2, characterized in that a liquid limit of the locking element is lower than a liquid limit of the collision element (11), wherein the locking element is preferably made of a first plastic or comprises a first plastic and the collision element is preferably made of a second plastic or comprises a second plastic.

8. A locking mechanism according to any of claims 1 and 2, characterized by a lock aperture, wherein the locking element has a first section comprising, in cross-section, a lateral extension, which substantially corresponds to a width of the lock aperture, wherein the collision element and the locking element are configured such that during a collision of the locking element with the collision element, the first section of the locking element plunges into the locking aperture at least partially and frictionally engages the lock aperture.

9. A locking mechanism according to claim 5, characterized in that the first stop is arranged on the lock aperture.

10. A locking mechanism according to any of claims 1 and 2, characterized in that the locking element comprises a second hook and the collision element and the locking element are configured such that when the locking element collides with the collision element the second hook engages behind a third stop at least in part.

11. A storage compartment, comprising a box with an engagement aperture, a pivotable lid for closing the engagement aperture and a locking mechanism according to any of claims 1 and 2, characterized in that the locking element is pivotally connected with the lid and the collision element is rigidly connected to the box or forms a part of the box.
